(19) United States
(12) Patent Application Publication
(10) Pub. No.: US 2007/0280632 A1
(43) Pub. Date: Dec. 6, 2007

(54) Edit Decision Recording Device in a Multi-Camera Video Recording System and Integrated Video Recording and Editing System Containing the Same

(76) Inventor: Evangelos Achillopoulos, Athens (GR)

Correspondence Address: FERENCE & ASSOCIATES LLC, 409 BROAD STREET, PITTSBURGH, PA, 15143, US

(21) Appl. No.: 10/558,210

(22) PCT Filed: May 25, 2004
(86) PCT No.: PCT/GR04/00031

§ 371 Date: Dec. 5, 2006

(30) Foreign Application Priority Data
May 26, 2003 (GB) 20030100237

(51) Int. Cl. G11B 27/00

(52) U.S. Cl. 386/52; 386/E05.003

(57) ABSTRACT

The invention relates to an integrated multi-camera recording and editing system for a TV production. The system records on magnetic storage media the takes from all cameras, as well as the master tape created after selection of the takes by the director. In addition, using the camera selection signals (“camera tally output”) from the video mixer, it automatically creates an internal edit decision list that is directly usable by the editing section of the original recording of the production to facilitate and speed up the editing process.

The present invention is directed to the field of video recordings and particularly to the procedures of recording and processing (editing) primary video footage.

Production of a TV program requires a laborious and time-consuming procedure. Thus, there is initially performed the shooting of “takes”, usually from multiple cameras, of a TV program, for instance of a TV serial, commercial, game, etc. The director of the production selects the takes to be used, among the multiple takes from the multiple cameras.

The sequence of the selected takes is recorded on a magnetic medium, typically a videotape that constitutes the initial master tape of the production. Simultaneously, all the shots from all cameras are recorded separately on additional videotapes. After the end of a working day of shooting, all this material is transported in a post-production (editing) laboratory, where the final processing of the production, comprising corrections, deletions, additions and changes of points of view, is performed. All these procedures are time-consuming and fairly hard to perform and require a perfect synchronization between the various takes during change-over.

Additionally, in the newer (“non-linear”) editing systems, multiple transfers of video data between tapes and hard disk and vice-versa degrades image quality.

U.S. Patent No. 200220175931 A1 (Holz et al.) discloses a system for organizing a TV production in advance and creating a “scenario” that is executed at the time of the recording. It is not concerned with the post-production phase of the TV production, and the script file that it creates does not comprise decisions made during the live production stage. Furthermore, it does not disclose the recording of the primary material from all sources and its hierarchical organization in a tree structure.

From-European Patent Application No EP 0424903 A2 (NEC) it is known a method of organizing video or audio data in compact disk or similar magnetic recording medium. This method concerns data that are definitively and immovably recorded and their organization after the post-production stage; it is directed to the distribution stage of a production and not to the live production and post-production stages.

The object of the present invention is to overcome the above-mentioned disadvantages. In particular, the present invention proposes a system of recording and editing of TV productions in which the total production time is significantly reduced.

Further, the present invention proposes a system of recording and editing of TV productions in which the procedure of editing of the recordings is greatly facilitated.

Finally, the present invention provides a system of recording and editing of TV productions that gives an improved image quality.

Accordingly, the present invention consists in an integrated system of recording and editing of a TV production with multiple cameras, which comprises:
multiple sources of video image that provide an output of different points of view of the scene or other video image sources;
an input signal selector;
an audio mixer, optionally with multiple output channels;
a video mixer, which receives the different points of view from the multiple sources of video image and provides in the output the point of view of the source selected by the input signal selector;
a takes storage system, capable of storing on a random access magnetic recording medium all the outputs from the multiple sources and from the video and the audio mixers;
a video recording editor able to use the material that is stored in the takes storage system and to create, using the appropriate software, an edited form of the video production;
   characterized in that the takes storage system receives from the video mixer a camera selection signal and uses that signal to create an edit decision list directly usable by the video recording editor or available to an external processing system.

The invention will be described in further detail with reference to the attached drawings, in which:

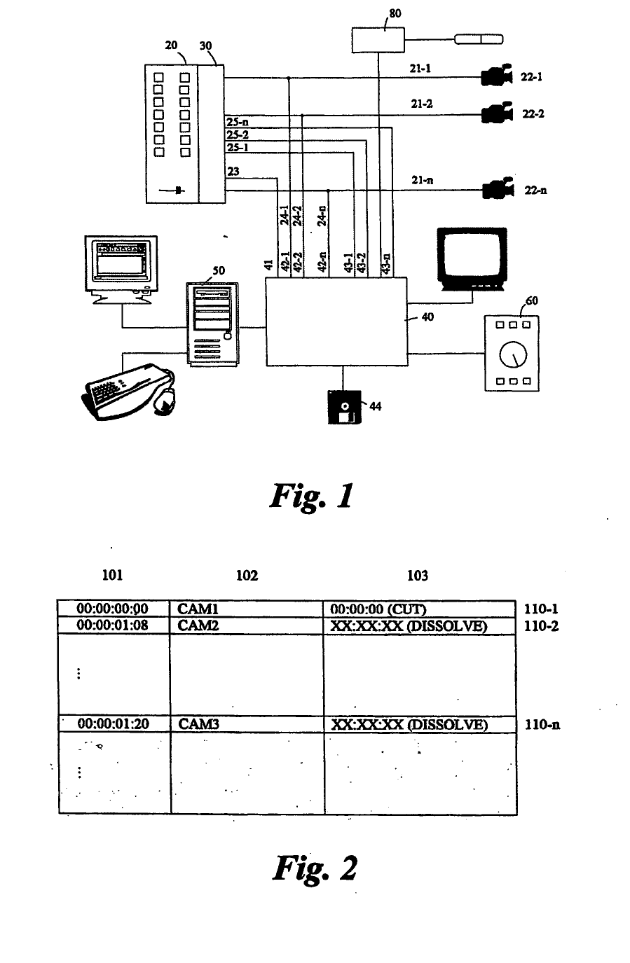

FIG. 1 is a schematic diagram of the recording and editing system of a TV production according to the present invention;

FIG. 2 is a portion of an Edit Decision List created by the system of FIG. 1.

FIG. 1 shows a schematic diagram of a preferred embodiment of the recording and editing system of the present invention. The system, indicated generally with the numeral 10, comprises a video mixer 20, that receives output signals 21-1, 21-2, . . . , 21-n from multiple video sources 22-1, 22-2, . . . , 22-n. Each video source signal represents a different point of view (“angle”).

A point of view selector 30 selects, among these output signals 21-1, 21-2, . . . , 21-n, the one that will be used in the original of the production. The selected output is transmitted as a signal output 23 from the video mixer 20. Simultaneously, the video mixer 20 transmits in addition the output signals 24-1, 24-2, . . . , 24-n from all video cameras (or other video sources) 22-1, 22-2, . . . , 22-n. Additionally, the video selector transmits a status indication (“tally output”, selected/non-selected/transition) for each video camera 25-1, 25-2, . . . , 25-n. The system includes also commonly an audio mixer 80 with multiple output channels.

The takes storage system 40 receives, in appropriate signal inputs 41, 42-1, 42-2, . . . , 42-n, the selected signal output 23 and the corresponding output signals 24-1, 24-2, . . . , 24-n from the video cameras. In addition, the takes storage system 40 receives in inputs 43-1, 43-2, . . . , 43-n the corresponding status indications 25-1, 25-2, . . . , 25-n.

The signals are recorded separately on random access magnetic storage media 44, such as for example magnetic disks, after their conversion in an appropriate digital form (e.g. DV50, MPEG2, etc.). At the same time, the takes storage system creates an Edit Decision List (EDL), using the changes in the status indications that it receives on inputs 43-1, 43-2, . . . , 43-n.

In FIG. 2 there is shown a portion of such an Edit Decision List file 100. As seen, the file consists of a multiplicity of sequential entries 110-1, 110-2, . . . , 110-n. Each entry comprises essentially the following fields:
time signature field 101: it contains the distance in time between the start of the action and the start of the production in the form hours:minutes:seconds: frames
selected input field 102: it contains the number of the source (or, equivalently, of the magnetic disk file where its output is recorded) from which the point of view has been included in the original (master) of the production
transition mode field 103: it contains a number that represents one of a series of possible modes of transition from a point of view to the next (cut or dissolve, as indicated by this number, where 0 means cut and ≠0 means a transition duration).

All those files are available to the video recording processor (non-linear editing system) 50, for their final processing and the creation of the definitive, edited master tape of the TV production. Additionally, the Edit Decision List can be exported in a form compatible with other commercial editing systems, such as: “AAF”, “MXF”, etc.

According to an especially preferred embodiment of the invention, all the storage system control operations that can be performed from the control station can be displayed in the form of drop-down menus on any TV set and controlled by means of a jog/shuttle control box 60 from the control position.

According to another especially preferred embodiment of the invention, the primary material from the video image sources is hierarchically organized in a tree-like configuration during storage (e.g. according to an episode:scene:take scheme for a TV serial; or a event:part:segment scheme for the broadcasting of a sports event). In this manner the search procedure of the primary material is simplified.

Finally, in a further special case relating to the live broadcasting of sports events, there is provided the ability of storing at will, in a separate file, of marking and of hierarchical organization of defined time intervals (e.g. ±10 seconds) about a particular incident. For example, by pushing at the control station 60 a button which, for a particular application, is labeled “goal”, “foul”, etc., a copy is automatically created of the Edit Decision List file for the 10 seconds immediately preceding and the 10 seconds immediately following the moment at which the button was pushed, this copy is labeled according to the above described hierarchical tree structure, depending on the button that caused its storage, and can eventually be searched using this labeling.

The above described recording and editing system for a TV production according to the present invention has the following advantages when compared with the presently available similar systems:
1. Integration: the system provides the functions of point of view selection and of editing of a TV production within a single assembly. The system is compatible with all video mixers.
2. Improved quality:. owing to the fact that all operations are performed under the same format, transfers from video cassette or tape to disk are avoided, and thus also any degradation of quality due to the conversion between analog and digital form or between different digital encodings.
3. Functionality: editing can be performed concurrently, or within a very short delay after the recording. This allows the director of the production to visualize the final form of the scene and to make immediate decisions, such as for example to re-record a take of the scene.
4. Flexibility: Due to the common timeline for all points of view, changes (such as deletions, additions, changes of point of view or other source) can be made directly, and the results be controlled and modified quickly.
5. Reduction of total work time: This is because editing can be performed concurrently with the recording, owing to the creation of the Edit Decision List file, while there is also no time delay for the storage in digital form of the signals from the takes. This reduction can be of the order of 10-12 hours per work day in the preferred embodiment.
6. Cost reduction: The cost reduction results from various factors. On the one hand, there is no cost associated with the storage of the signals derived from the cameras (cost of acquisition and maintenance of video recorders, tapes, etc.), while on the other hand there is a cost reduction in all aspects of the production due to the increased productivity.

It is understood that the above described preferred embodiment of the invention does not limit its scope, which is defined in the claims. Further, it is expected that one skilled in the art can perform changes and modifications to the invention within its scope.

1. System (10) for recording and editing of a TV production with multiple cameras, which comprises:
multiple sources of video image (22-1, 22-2, . . . , 22-n) that provide an output of different points of view (21-1, 21-2, . . . , 21-n) of the scene or other video image sources;
an input signal selector (30);
an audio mixer (80), optionally with multiple output channels;
a video mixer (20), which receives the different takes from the multiple sources of video image and provides in the output (23) the take of the source selected by the input signal selector (30);
a takes storage system (40), capable of storing on a random access magnetic recording medium (44) all the outputs from the multiple sources and from the video (20) and the audio (80) mixers;
a video recording editor (50) capable of using the material that is stored in the takes storage system and to create, using the appropriate software, an edited form of the video production;
characterized in that the takes storage system (40) receives from the video mixer (20) a camera selection signal (25-1, 25-2, . . . , 25-n) and uses that signal to create an edit decision list (100) directly usable by the video recording editor (50) or available to an external processing system in a form compatible therewith.

2. System according to claim 1, characterized in that said edit decision list (100) contains additional information, relating to the mode of transition between sources.

3. System according to claim 1 or 2, characterized in that all the takes storage system (40) control functions are performed from a control station (60) and can be displayed in the form of drop-down menus on any TV set and controlled with a jog/shuttle control box from the control station (60).

4. System according to any one of claims 1 to 3, characterized in that the primary material derived from the video image and audio sources is hierarchically organized in a tree-like configuration during storage.

5. System according to any one of claims 1 to 3, characterized in that it provides the potential for the selective storage in a separate edit decision list file (100), labeling and hierarchical organizing in a tree-like structure of defined time intervals about a particular incident.
